(19) United States
(12) Patent Application Publication
(10) Pub. No.: US 2011/0179219 A1
(43) Pub. Date: Jul. 21, 2011

(54) HYBRID STORAGE DEVICE

(75) Inventors: Abraham C. Ma, San Jose, CA (US); Charles C. Lee, Cupertino, CA (US); I-Kang Yu, Palo Alto, CA (US); Shimon Chen, Los Gatos, CA (US)

(73) Assignee: Super Talent Electronics, Inc., San Jose, CA (US)

(21) Appl. No.: 13/076,369

(22) Filed: Mar. 30, 2011

Related U.S. Application Data
(63) Continuation-in-part of application No. 12/186,471, filed on Aug. 5, 2008.
Application No. 12/186,471 is a continuation-in-part of application No. 12/054,310, filed on Mar. 24, 2008, now Pat. No. 7,877,542.
Application No. 12/054,310 is a continuation-in-part of application No. 12/035,398, filed on Feb. 21, 2008, now Pat. No. 7,953,931.
Application No. 12/035,398 is a continuation-in-part of application No. 11/770,642, filed on Jun. 28, 2007, now Pat. No. 7,889,544.
Application No. 11/770,642 is a continuation-in-part of application No. 11/748,595, filed on May 15, 2007, now Pat. No. 7,471,556.
Application No. 11/748,595 is a continuation-in-part of application No. 10/818,653, filed on Apr. 5, 2004, now Pat. No. 7,243,185.
Application No. 10/818,653 is a continuation-in-part of application No. 12/252,155, filed on Oct. 15, 2008.
Application No. 12/252,155 is a continuation-in-part of application No. 12/418,550, filed on Apr. 3, 2009.
Application No. 12/418,550 is a continuation-in-part of application No. 12/475,457, filed on May 29, 2009.
Application No. 12/475,457 is a continuation-in-part of application No. 13/032,564, filed on Feb. 22, 2011.

(51) Int. Cl. G06F 12/00

(52) U.S. Cl. 711/103; 711/E12.008

(57) ABSTRACT

A hybrid storage device comprises both solid-state disk (SDD) and at least one hard disk drive (HDD). The hybrid storage device has at least two operational modes: concatenation and safe. According to one aspect, the total capacity of hybrid storage device is the sum of SSD and at least one HDD in a concatenation or big mode, while the total capacity is the capacity of the HDD in a safe mode. In one embodiment, HDD is configured for storing a copy of the SSD's contents in a reserved area. In another, SSD comprises more than one identical flash memory devices controlled by a RAID controller.

### CROSS REFERENCE TO RELATED APPLICATIONS

This application is a continuation-in-part (CIP) of “Multi-Level Controller with Smart Storage Transfer Manager for Interleaving Multiple Single-Chip Flash Memory Devices”, U.S. Ser. No. 12/186,471, filed Aug. 5, 2008, which is a CIP of “High Integration of Intelligent Non-Volatile Memory Devices”, Ser. No. 12/054,310, filed Mar. 24, 2008, which is a CIP of “High Endurance Non-Volatile Memory Devices”, Ser. No. 12/035,398, filed Feb. 21, 2008, which is a CIP of “High Speed Controller for Phase Change Memory Peripheral Devices”, U.S. app. Ser. No. 11/770,642, filed on Jun. 28, 2007, which is a CIP of “Local Bank Write Buffers for Acceleration a Phase Change Memory”, U.S. app. Ser. No. 11/748,595, filed May 15, 2007, which is CIP of “Flash Memory System with a High Speed Flash Controller”, application Ser. No. 10/818,653, filed Apr. 5, 2004, now U.S. Pat. No. 7,243,185.

This application is also a CIP of co-pending U.S. patent application for “Command Queuing Smart Storage Transfer Manager for Striping Data to Raw-NAND Flash Modules”, Ser. No. 12/252,155, filed Oct. 15, 2008.

This application is also a CIP of co-pending U.S. patent application for “Hybrid 2-Level Mapping Tables for Hybrid Block- and Page-Mode Flash-Memory System”, Ser. No. 12/418,550, filed Apr. 3, 2009.

This application is also a CIP of co-pending U.S. patent application for “Multi-Level Striping and Truncation Channel-Equalization for Flash-Memory System ”, Ser. No. 12/475,457, filed May 29, 2009.

This application is also a CIP of co-pending U.S. patent application for “Hybrid Storage Device”, Ser. No. 13/032,564, filed on Feb. 22, 2011.

### FIELD OF THE INVENTION

This invention relates to hybrid storage devices configured for massive data storage, more particularly to hybrid storage devices that are made of a combination of solid state disk (i.e., non-volatile flash memory based storage) plus one or more hard disks.

### BACKGROUND OF THE INVENTION

Solid-state disk (SSD) is a data storage device that uses solid-state memory to store persistent data. Generally, an SSD is configured to emulate a hard disk drive interface, thus easily replacing it in most applications. With advance of non-volatile memory (e.g., NAND based flash memory), most SSDs are built with non-volatile memories. It is noted that mass storage devices are block-addressable than byte-addressable (e.g., each sector contains 512-byte of data, several sectors are grouped into a page, a block contains a number of pages).

NAND flash memory is a type of flash memory constructed from electrically-erasable programmable read-only memory (EEPROM) cells, which have floating gate transistors. These cells use quantum-mechanical tunnel injection for writing and tunnel release for erasing. NAND flash is non-volatile so it is ideal for portable devices storing data.

Hard disk drive (HDD) is a non-volatile, random access device for storing massive digital data. It features rotating rigid platters on a motor-driven spindle within a protective enclosure. Data is magnetically read from and written to the platter by read/write heads that float on a film of air above the platter. Because HDD contains mechanical parts, it is bound to have a slower data access speed due to physical constraints such as requiring spin-up to steady state, seek data. Other disadvantages include noise, fragile parts, etc.

Generally, SSD provides faster data access comparing to HDD but its cost and capacity may prevent a product economically feasible. On the other hand, HDD has the aforementioned shortcomings and problems. It would, therefore, be desirable to have an SSD coupling to one or more hard disk drives to form a hybrid storage device.

### SUMMARY OF THE INVENTION

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

A hybrid storage device comprises both solid-state disk (SDD) and at least one hard disk drive (HDD). The hybrid storage device has at least two operational modes: concatenation and safe. According to one aspect, the total capacity of hybrid storage device is the sum of SSD and at least one HDD in a concatenation or big mode, while the total capacity is the capacity of the HDD in a safe mode.

According to another aspect, a hybrid storage device includes a controller that can be switched between concatenation and safe modes. The controller keeps tracking of the data access frequency of each data unit (e.g., 1,024-byte) such that frequently recent accessed data units are stored in SSD while the least-recent-accessed data units in HDD. Determination of frequently accessed and least recent used data units can be done with a data access frequency application from a host. The data access frequency application can also be viewed as an intelligent tracking means for detecting user's activities over a period of time.

According to yet another aspect, the frequently used data can be determined by the user. In other words, the user can specify which data files or applications to be stored in faster storage (i.e., SSD) to ensure a faster data access and/or application start-up time. The application module that allows user to specify files and/or applications can be based on artificial intelligence.

According to yet another aspect, a threshold for determining least-recent-accessed data is dynamically established with a set of rules created from the data access patterns. According to still another aspect, the threshold is determined with a predefined value statically.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1A is a diagram illustrating a hybrid storage device made of one SSD and at least one HDD;

FIG. 1B is a diagram showing various exemplary interfaces of a hybrid storage device;

FIG. 1C is a diagram showing an exemplary hybrid device made of one SSD and at least one HDD having a reserved area for storing a copy of the SSD's contents;

FIG. 1D is a diagram showing an exemplary hybrid device made of one SSD controlled by a RAID controller and at least one HDD having a reserved area for storing a copy of the SSD's contents;

FIGS. 2A and 2B are diagrams illustrating a hybrid storage device having a concatenation controller;

FIG. 2C is a diagram illustrating a hybrid storage device having a SSD based data cache;

FIG. 3A is a functional block diagram showing data to be stored in a SSD;

FIG. 3B is a diagram showing salient components of the data structure of FIG. 3A;

FIG. 4 is a flowchart illustration an exemplary process of storing data in a hybrid storage device;

FIG. 5 is a diagram showing data structure of a hybrid storage device;

FIGS. 6A-6C are collectively a flowchart illustrating an exemplary data access operations of a hybrid storage device;

FIGS. 7A-7C are collectively a schematic diagram showing an exemplary process of data insertion in a hybrid storage device;

FIG. 8 is a diagram showing an exemplary data structure of a data mapping table used in a hybrid storage device;

FIGS. 9A-9B are diagrams showing a cache boundary effect in a hybrid storage device;

FIGS. 10A-10B are collectively a flowchart showing an exemplary data write operation in a hybrid storage device;

FIGS. 11A-11B are collectively a flowchart showing an exemplary data read operation in a hybrid storage device;

FIG. 12A is a flowchart showing an exemplary process of using a data access frequency threshold to determine data placement into SSD and HDD in a hybrid storage device;

FIG. 12B is a flowchart showing an exemplary process of using a file size threshold to determine data placement in the hybrid storage device;

FIGS. 13A-13D collectively show an example using the exemplary process of FIG. 12A;

FIG. 14 shows an example of using the exemplary process of FIG. 12B; and

FIGS. 15A-15B are collectively a flowchart illustrating an exemplary process of reducing startup time when a hybrid storage device is operatively adapted to a host.

### DETAILED DESCRIPTION

In the following description, numerous details are set forth to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

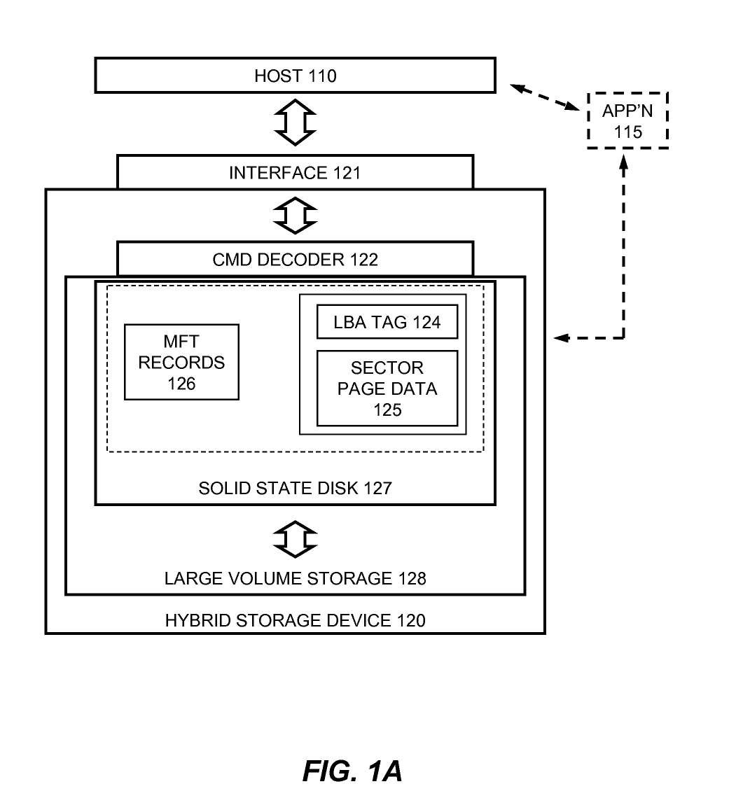

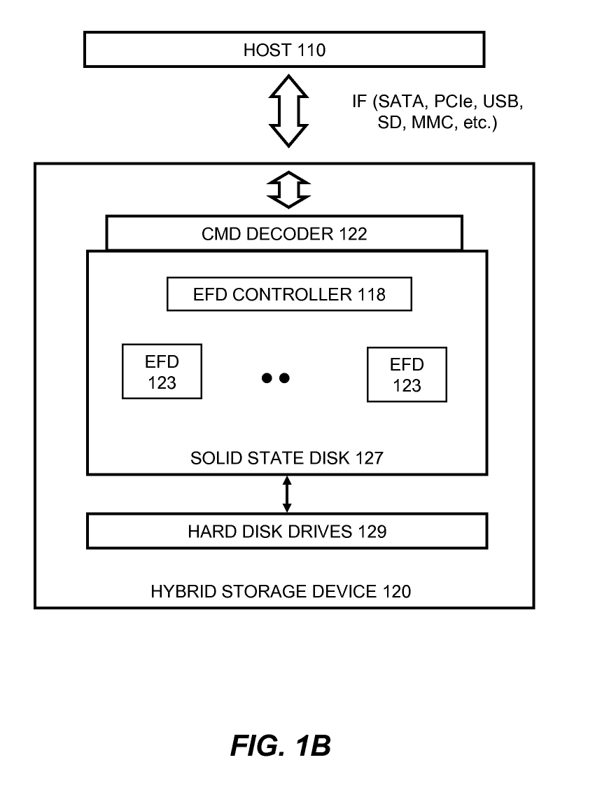

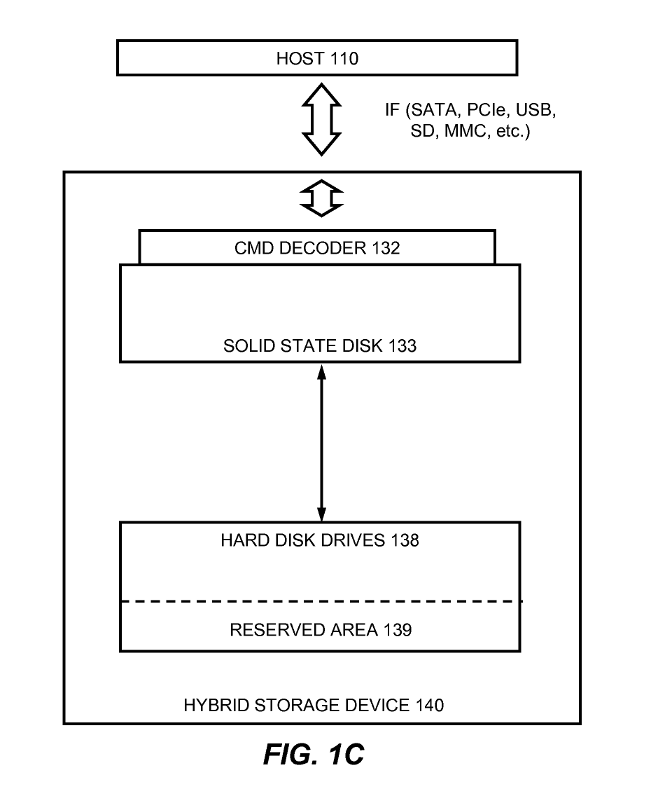

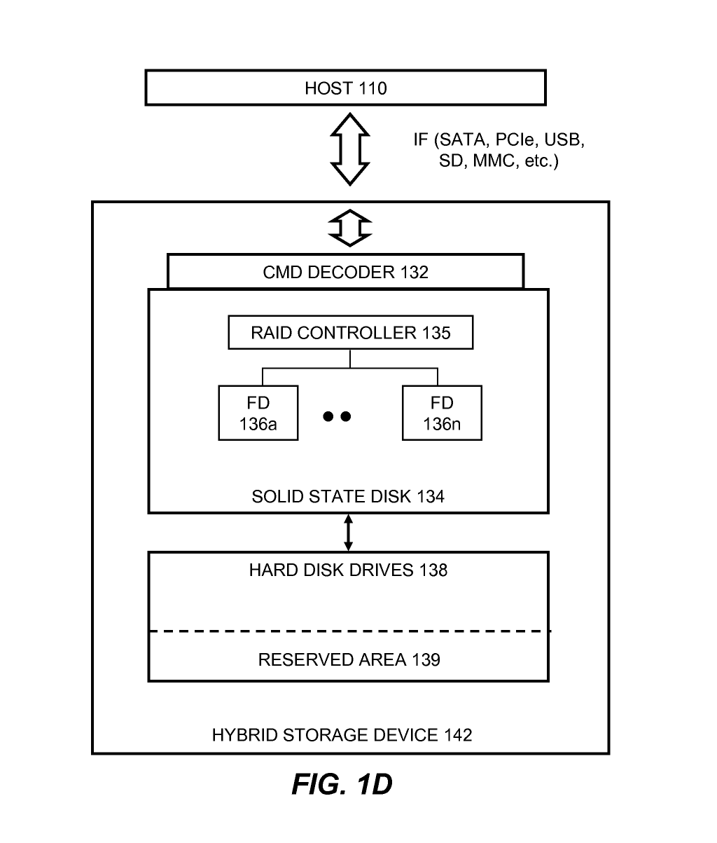

Embodiments of the present invention are discussed herein with reference to FIGS. 1A-15B. However, those skilled in the art will readily appreciate that the detailed description given herein with respect to these figures is for explanatory purposes as the invention extends beyond these limited embodiments.

Referring first to FIG. 1A, it is shown an exemplary hybrid storage system 120 and a host 110 (e.g., computer system, mobile platform, etc.). The hybrid storage system 120 comprises an interface 121, a command decoder 122, and large volume storage 128. The interface 121 is configured for data transmission with the host 110 via one of the standards (e.g., Universal Serial Bus (USB), Peripheral Component Interconnect Express (PCI-E), etc.). The command decoder 122 configured for decoding a data transmission command received from the host 110. Data transmission or transfer commands may include, but are not limited to, data read, data write. Large volume storage 128 may comprise one SSD 127 plus other storage media (e.g., hard disk drive (HDD), not shown). Critical system data are store in the SSD 127, for example, Master File Table (MFT) records 126, Master Boot Record (not shown), Basic Input/Output System (BIOS) Parameter Block (BPB) (not shown), and data mapping table that contains logical block address tag 124 and sector and page data indicator 125. Furthermore, a data access frequency application module 115 can be used for tracking data access frequency. Each data file may have an access sequence number that is incremented each time it has been reused. The data access frequency application can use the access sequence number in conjunction with the timestamp of the file to determine data access patterns. For example, in NTFS, each file record contains a field called “Sequence Number”, which is configured to store number of times this file record has been reused. Additionally, timestamps of the data file are stored in file attribute fields for file creation, file altered, etc.

Various standard interfaces shown in FIG. 1B can be implemented for the hybrid storage device 120, for example, USB, PCIe, Serial Advanced Technology Attachment (SATA), Security Digital (SD), MultiMediaCard (MMC), etc. These interfaces can also be implemented in embedded flash devices (EFD) 123 as embedded flash memory interface format (eSD, eMMC, etc.) instead of regular SATA interface. Also shown in FIG. 1B, one or more hard disk drives (HDD) 129 are used for forming the large volume storage 128. Embedded flash devices 123 are controlled by an embedded flash controller 118 (e.g., a Redundant Array of Independent Disks (RAID) controller).

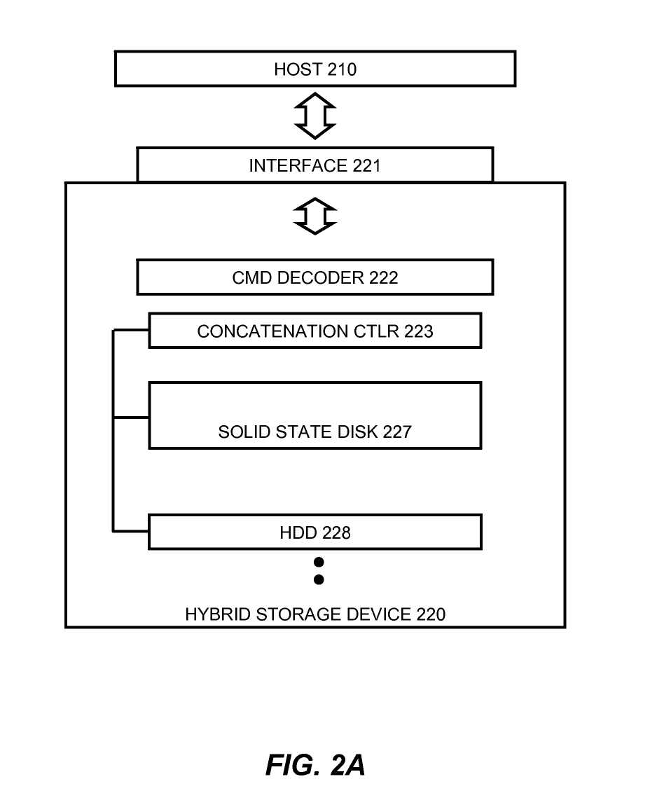

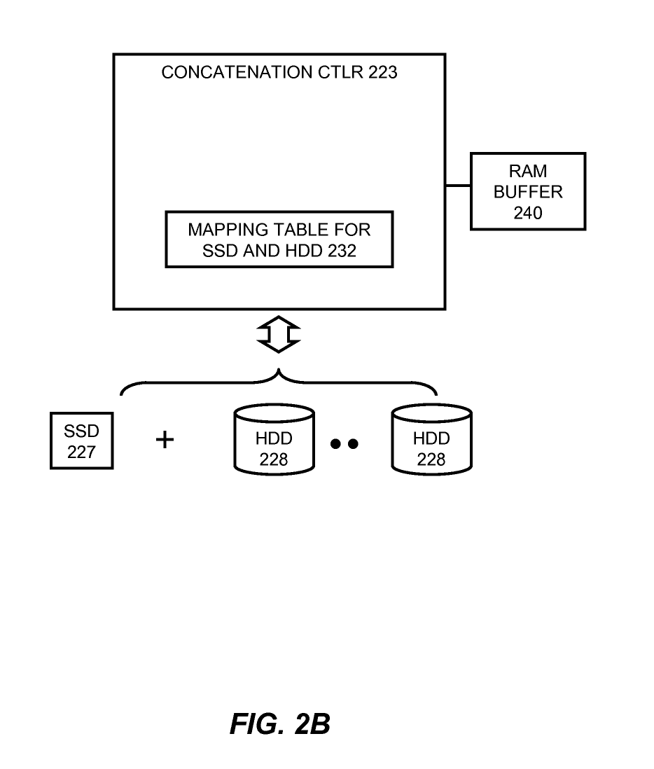

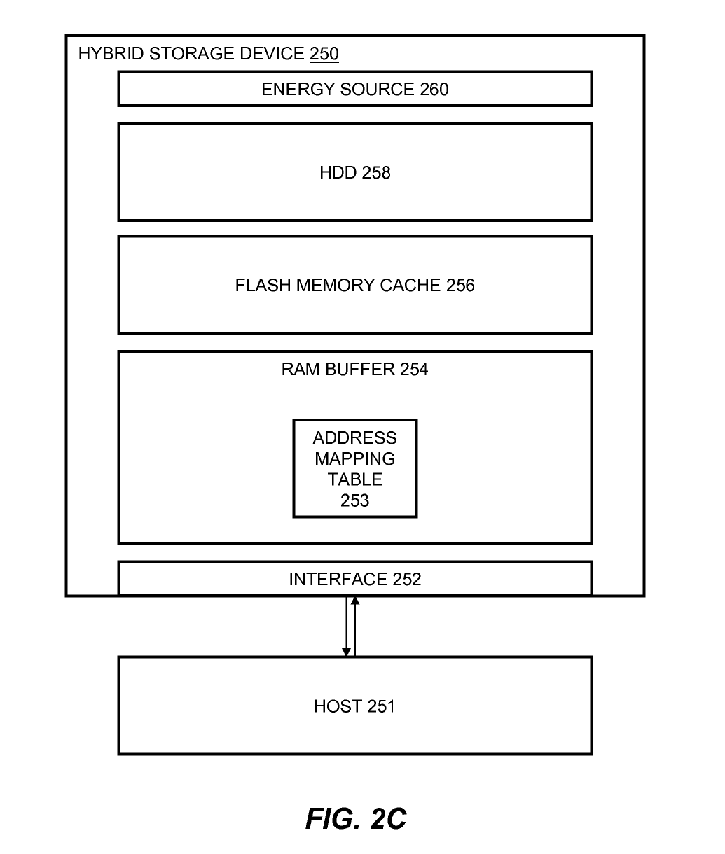

FIG. 1C shows another version of hybrid storage device 140 coupled to a host 110 via one of the communication interfaces (e.g., SATA, PCI-E, USB, SD, MMC, etc.). Hybrid storage device 140 contains a command decoder 132, one solid state disk (SSD) 133 and at least one hard disk drive (HDD) 138. HDD 138 includes a reserved area, which is configured for storing a copy of the SSD's contents. In other words, a backup copy is available on the HDD 138 when SSD 133 fails. This configuration is especially useful in the data concatenation or big mode shown in FIG. 2A.

FIG. 1D shows another hybrid storage device 142, which is a variation of hybrid storage device 140 shown in FIG. 1C. Hybrid storage device 142 includes substantially similar components except a RAID based SSD 134 is different. The RAID based SSD 134 includes more than one identical flash memory devices (FDs) 136a-n. FDs 136a-n are controlled by a RAID controller 135. For example, in a RAID-1 configuration, two FDs are mirrored to each other to provide higher data availability. Any one of the FDs fails, a new FD can be hot swapped (i.e., removing the out-of-order FD and replacing a new FD without shutting down the hybrid storage device 142). Other RAID configurations can also be used for providing different levels of data availability and product reliability. Additionally, a copy of the FD's contents is stored in the reserved area or data section 138 of the HDD 139 to provide further data retention or availability.

An exemplary hybrid storage device 220 configured for data concatenation or big mode is shown in FIG. 2A. The hybrid storage device 220 comprises an interface 221, a command decoder 222, and a concatenation controller 223, which controls one SSD 227 and at least one HDD 228. Concatenation controller 223 configures the SSD 127 and at least one HDD 228 into one logical disk partition such that the capacity of the hybrid storage device 220 is the capacity of the SSD 277 and the at least one HDD 228 combined.

FIG. 2B shows a different view of the concatenation controller 223. A random access memory (RAM) buffer 240 is operatively coupled to the concatenation controller 223, a data mapping table 232 is configured in the concatenation controller 223 for tracking data storage locations. Another function of the data mapping table 232 is used for tracking the data access frequency of each data unit. Although RAM buffer 240 is shown located outside of the concatenation controller 223, the RAM buffer 240 can be embedded inside.

FIG. 2C is a block diagram showing another exemplary hybrid storage device 250, which comprises an interface 252, a RAM buffer 254, a flash memory cache 256, at least one HDD 258 and an energy source 260. RAM buffer 254 is configured for storing a data mapping table 253. The flash memory cache 256 can be a SSD. The interface 252 is configured for data transmission to a host 251. This configuration is referred to as a safe or data cache mode of the hybrid storage device.

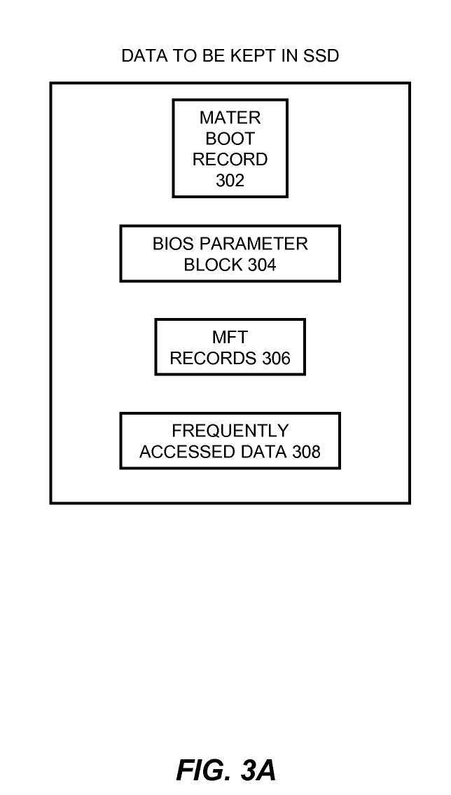

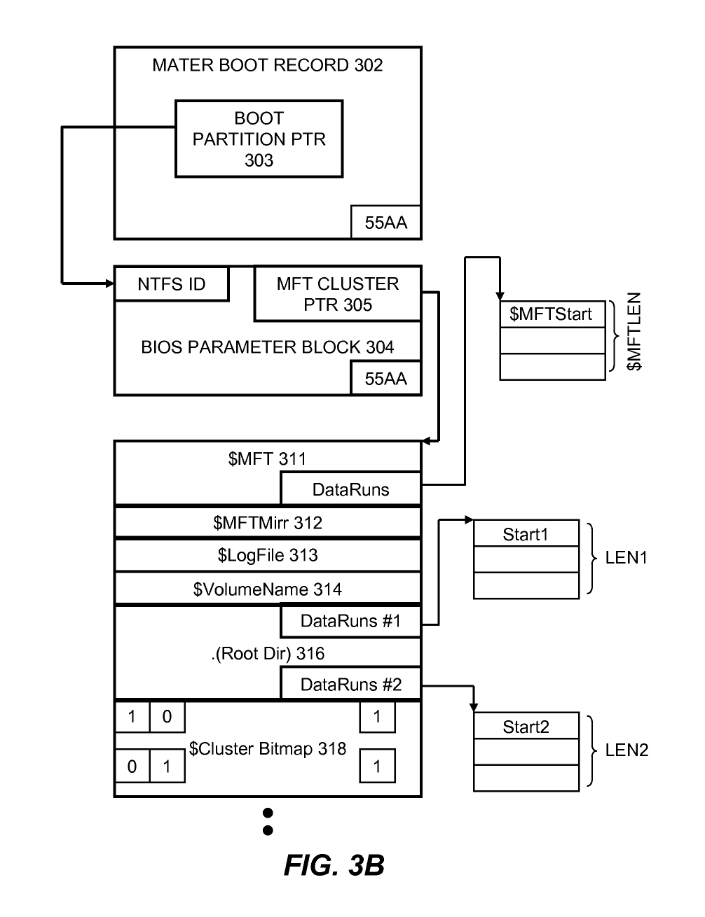

In order to achieve the advantage of a hybrid storage device, critical system data (e.g., MBR 302, BPB 304 and MFT records 306) and frequently accessed data units 308 are stored in SSD (as shown in FIG. 3A), while the least-recent-used data units are stored in HDD. In other words, faster data access can be achieved by storing frequently used data and critical system data for start-up operations in a relatively faster storage medium (in this case SSD).

According to one embodiment, one data unit is 1,024-byte. A more detailed diagram showing critical system data is in FIG. 3B. MBR 302 is generally a first group of data in a file system (e.g., New Technology File System (NTFS)). The end of the first group is indicated with a special token (e.g., a hexadecimal address “55AA” in NTFS). Generally, the second group of critical data is identified from the first group. For example, a Boot Partition Pointer 303 for NTFS indicates the location or address of BPB 304. Under NTFS, BPB 304 starts with an NTFS identifier (NTFS ID) and ends with a special address (“55AA”). Again within the second group of critical system data, there is a link to a third group of critical data. In NTFS, this link is referred to as MFT cluster pointer 305, which identifies the location or address of the third group of the critical system data (e.g., MFT records under NTFS). Within MFT records, there are a number of data units. Each data unit is assigned or configured to store specific data (e.g., $MFT 311, $MFTMirr 312, $LogFile 313, $VolumeName 314, Root directory (“.”) 316 and $Cluster Bitmap 318). Each of the data units may contain a data run or a number of data runs. When a particular data unit does not have enough capacity to store the information, one or more data runs are configured to link that particular data unit to another location or address. Data run contains a start address and length in general.

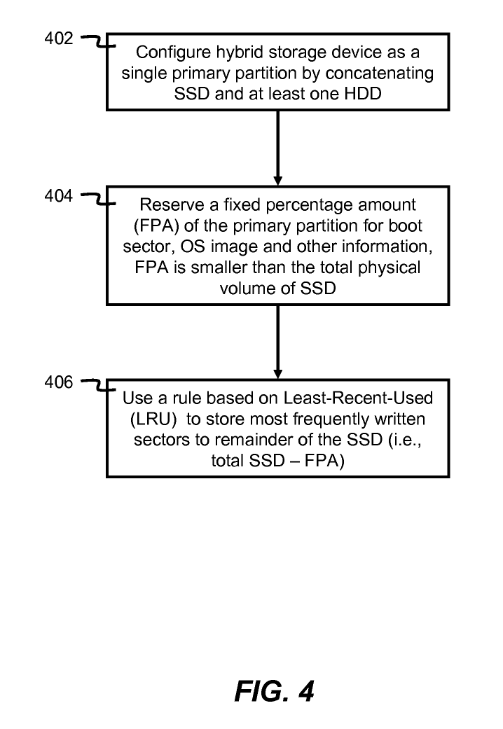

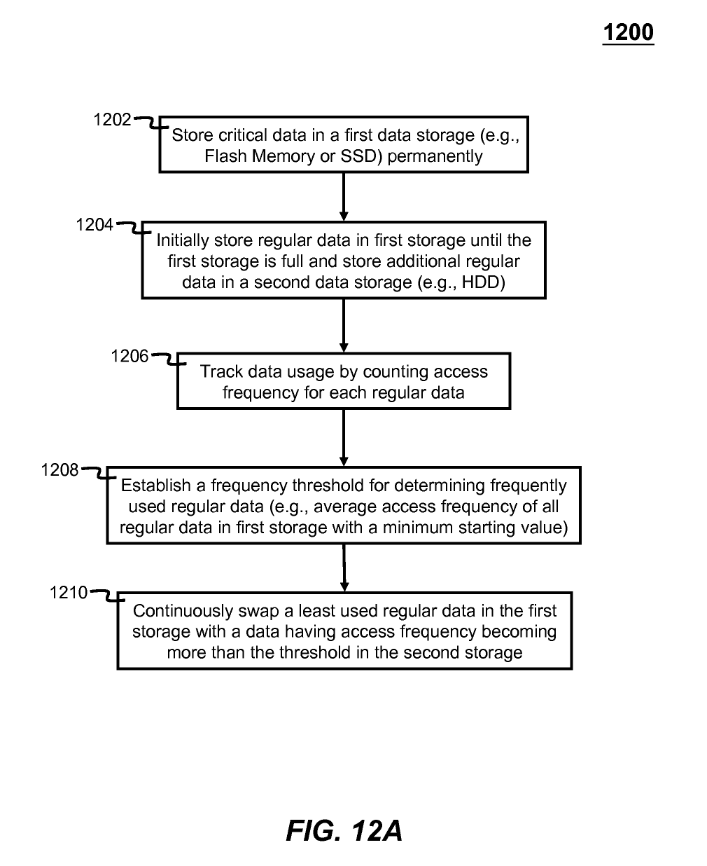

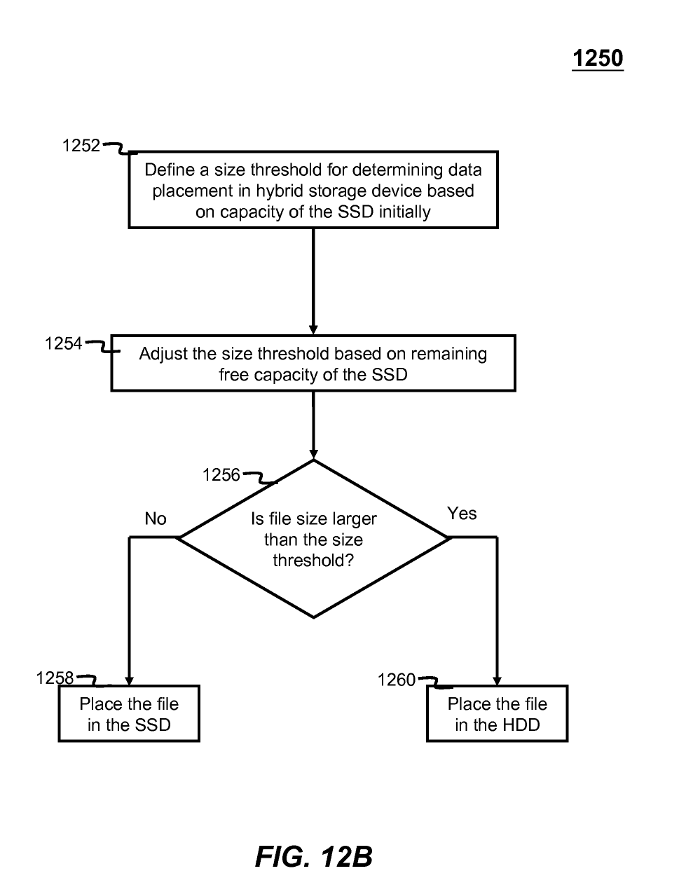

FIG. 4 is a flowchart illustrating an exemplary concatenation process. At the onset, a single logic partition is created by concatenating one SSD and at least one HDD together at step 402. In other words, a single virtualized storage space is created using heterogeneous devices (e.g., SSD and one or more HDD). This is generally performed by a concatenation controller 223 in FIG. 2. Next, at step 404, a fixed percentage of total physical capacity of the SSD is reserved for storing critical system data. In one embodiment, the reserved amount is referred to as fixed percentage amount (FPA). Remaining capacity of the SSD is used for storing frequently accessed data at step 406 using a rule based on least-recent-used data access patterns. An exemplary process is documented in an exemplary process shown in FIG. 12A below.

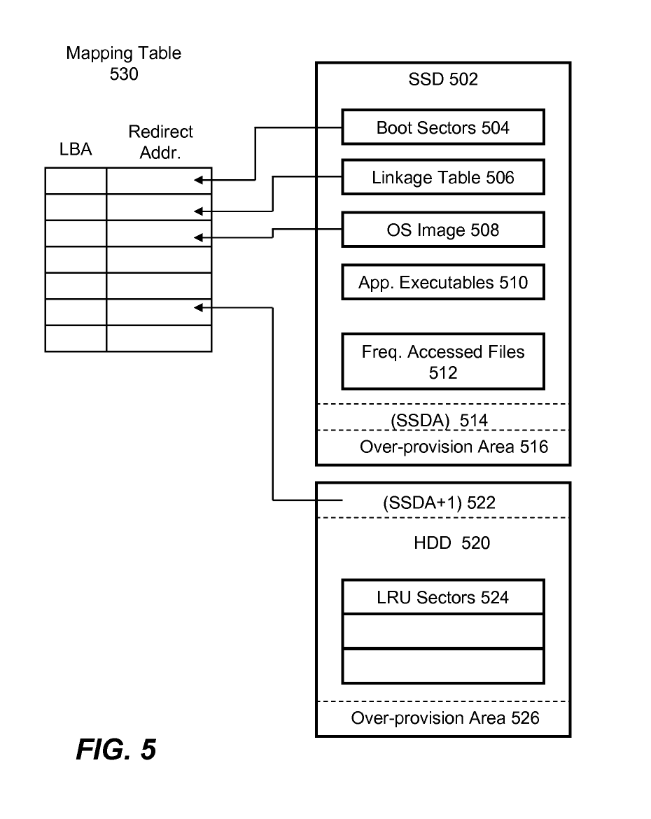

FIG. 5 shows an exemplary data mapping table 530, which contains logical block address (LBA) and redirect address for the data concatenation mode or big mode. Using the process shown in FIG. 4 as an example, the SSD 502 contains critical system data as follows: boot sectors 504, linkage table 506, Operation System (OS) image 508, and application executable 510. Frequently accessed data files 512 are stored in SSD 502. At the end of these files, it is indicated by an address (SSDA 514) in the single data partition. For SSD 502, an over-provision area or reserved area 516 is required for covering bad sectors. For at least one HDD 520, it is starts to store data in address (SSDA+1) 522 for the single data partition. Least-recent-used data 524 are stored therein. An over-provision area 526 is generally allocated at the end.

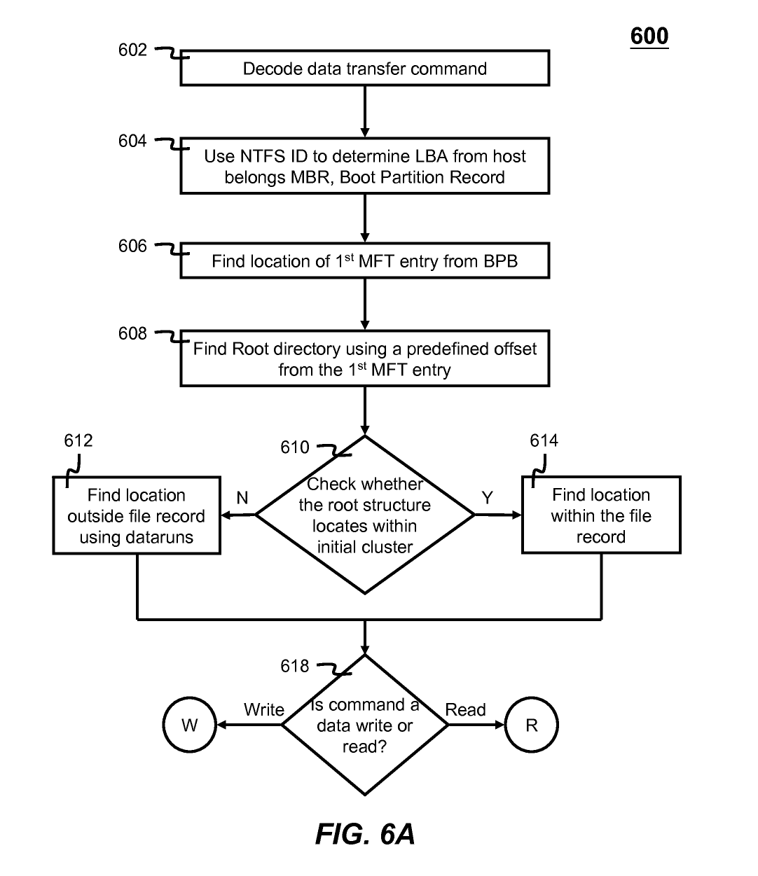

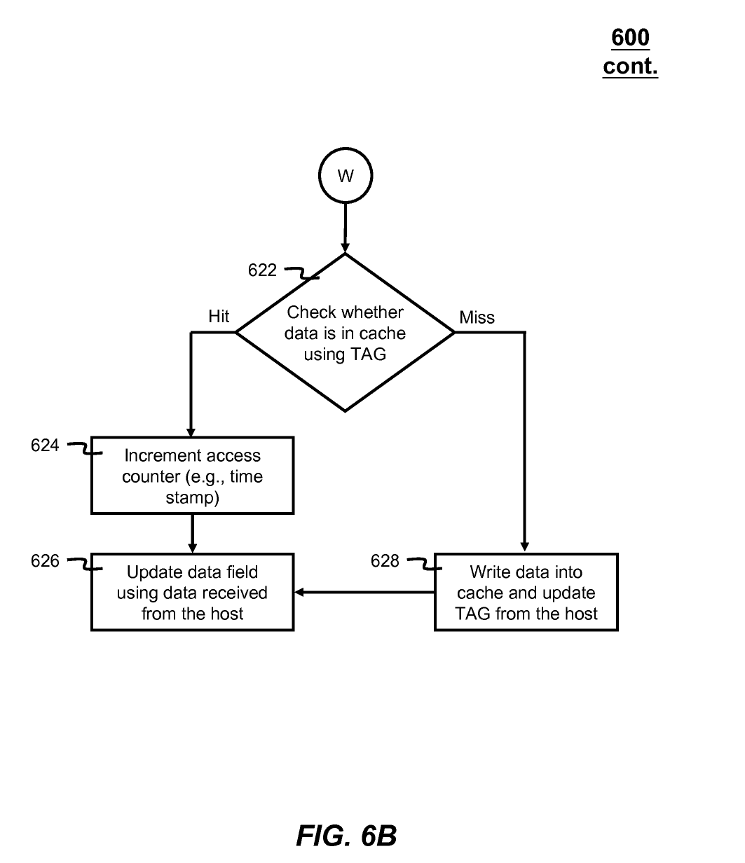

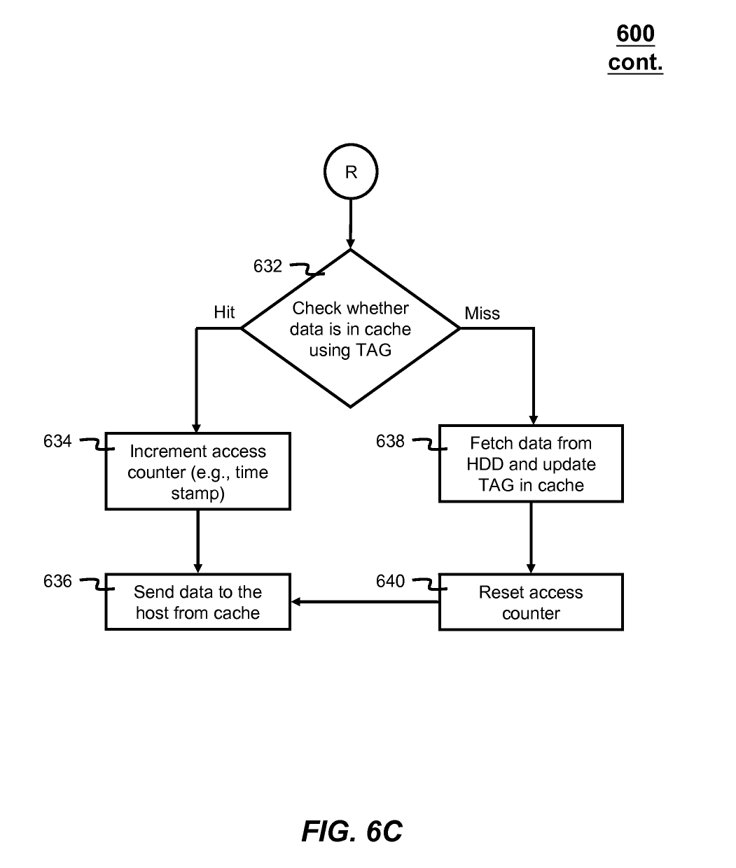

Referring now to FIGS. 6A-6C, they are collectively shown a flowchart illustrating an exemplary process 600 of data transmission operations in a hybrid storage device 250 shown in FIG. 2. Process 600 starts by decoding a data transfer command by the command decoder at step 602. For example, a data transfer command issued by the host 251 to the hybrid storage device 250 via the interface 252. Next at step 604, the command decoder examines the command using the identifier (e.g., NTFS ID) to determine the logical block address (LBA) belongs to MBR, BPB, or others. From BPB, the first entry location of the MFT records can be found at step 606. Then, the root directory can be located by a fixed offset from the first MFT record at step 608 (e.g., fixed number of bytes offset). Process 600 then moves to a decision 610 to determine whether the root directory is located within the local data unit. In other words, the decision 610 is to determine whether there is a data run contained in the local data unit therein. If “yes”, process 600 follows the “Y” branch to step 614 to find the location within the local data unit. Otherwise, process 600 moves to step 612 to locate the record using one or more data runs.

Nest, at decision 618, it is determined whether the data transfer command is a data read or data write. For the data write command, process 600 moves to another decision 622 to check whether the data is located in data cache 256 or not using tag of the LBA via address mapping table 253. If the data is not located in the cache, process 600 follows the “Miss” branch to step 628 to write the data into the cache 256 and update TAG in data mapping table from the host 251. Then the data field is updated with the received data from the host 251. Otherwise if the data is not located in the cache, process 600 follows the “Hit” branch to step 624 to increment the data access counter or frequency or timestamp before moving to step 628

If the command is determined to be a data read in decision 618, process 600 moves to decision 632 to check whether the data is located in data cache 256 or not. If “not” (i.e., cache miss), process 600 follows the “Miss” branch to step 638 to fetch data from HDD and to update corresponding tag in the data mapping table. Then the access count is reset at step 640. Finally at step 636, the data is sent to the host 251 from the data cache 256. If the data is determined to be located in cache (i.e., cache hit), process 600 follows the “Hit” branch to step 634 to increment the access counter or frequency or timestamp before moving to step 636.

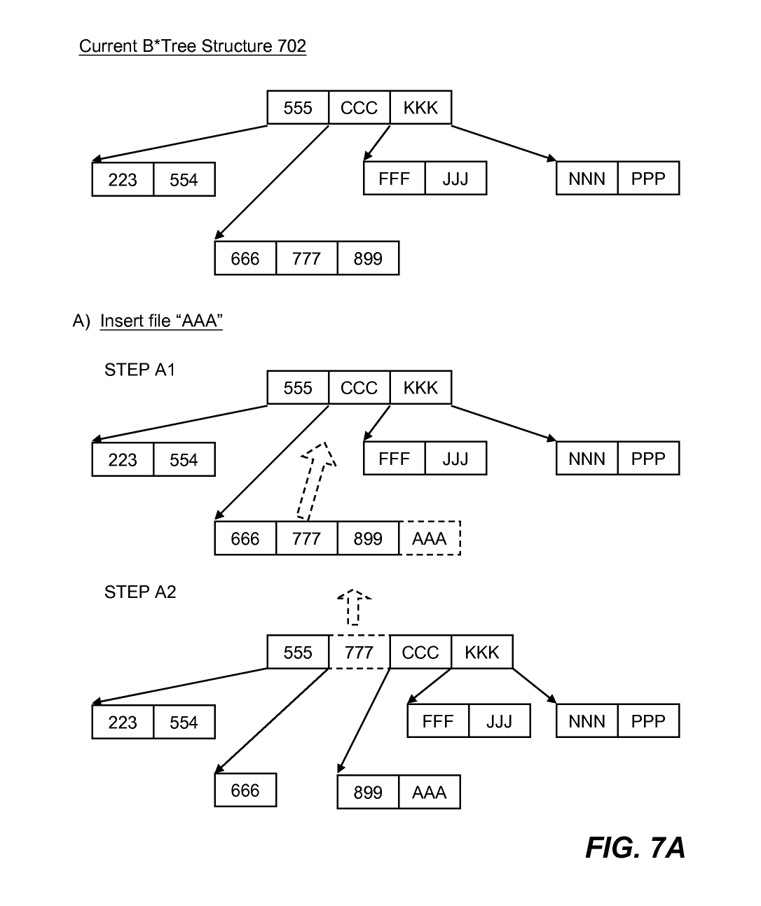

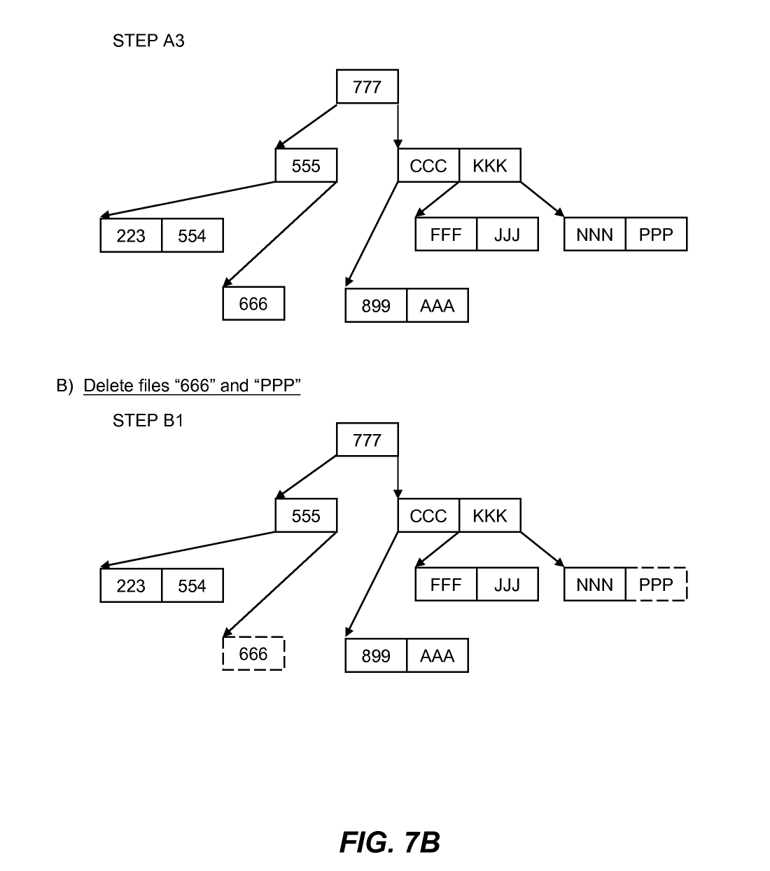

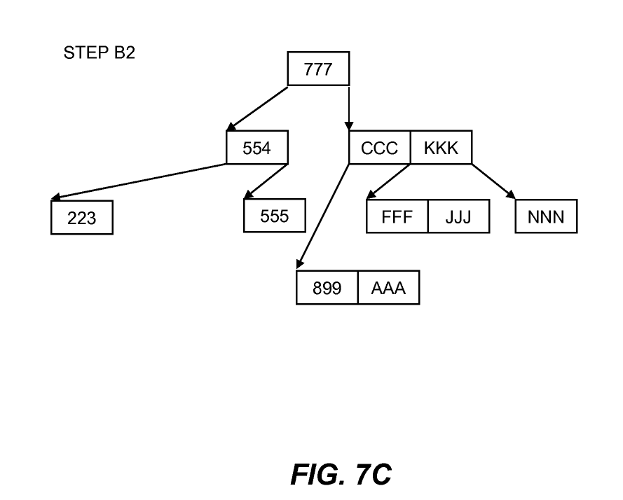

Referring now to FIGS. 7A-7C, it is shown an example to illustrate “B*Tree” structure and how data files are arranged using such scheme. For illustration simplicity, the exemplary B*Tree structure allows only three (3) entries at each node. Furthermore, numerical numbers are assumed to be placed before alphabets in this example. In many of the real-world implementations, each node could have up to 1024 entries or items.

At the onset, the current B*Tree structure 702 is shown. When a file named “AAA” to be inserted into the B*Tree structure (Example A), it requires three steps shown as follows: at STEP A1, “AAA” is to be added between “555” and “CCC”, which would require adding a new entry “AAA” into a lower level node already containing three file names: “666”, “777” and “899”. Since this node is full (three entries), one of the middle entries “777” needs to be moved to an upper level (indicated by an arrow formed by dotted outlines) when “AAA” is added to the end. Next at STEP A2, the entry “777” would need to be added into the upper level also full (containing “555”, “CCC” and “KKK”). Therefore, entry “777” would need to be moved up again (indicated by an arrow formed with dotted outline). It is noted that the lower level which entry “AAA” was added is broken into two nodes with one node containing one entry “666”, the other containing “899” and “AAA”. Finally, at STEP A3, entry “777” is located at a top level node, while the original top level is broken into two nodes. First node contains “555” and the second contains “CCC” and “KKK”.

Next (example B), file “666” and “PPP” are deleted from the resulting B*Tree structure after the above insertion example. File “PPP” can be deleted right away from the node at STEP B1. The resultant node contains one file “NNN”. However, file “666” is the only file in the node. After deleting file “666”, the node structure has been changed in STEP B2.

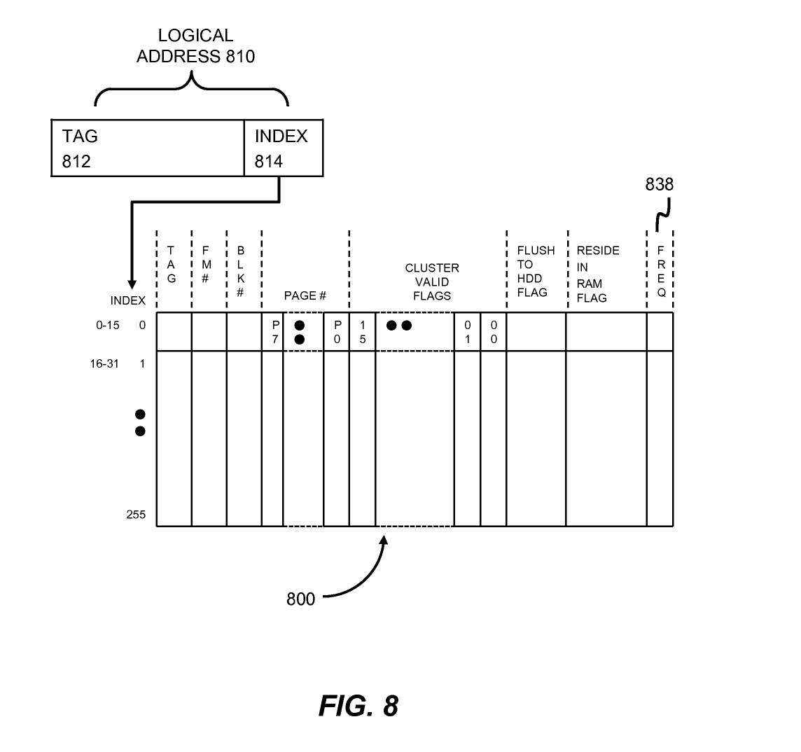

An exemplary data mapping table 800 is shown in FIG. 8. Each data transaction for either read or write requires a starting location and a data range. The starting location is generally represented as a logical address 810, which can be separated into at least two portions: tag 812 and index 814. Each index 814 corresponds to a cache line that holds a plurality of clusters or sectors. Tag 812 contains most significant bits of the logical address, while index 814 contains less significant bits. Using the hybrid storage device 250 shown in FIG. 2C as an example, the HDD 258 may have a capacity of 1024 GB with a flash memory cache 256 of 4 GB. Index 814 of such example has a range between 0 and 255, which is derived from dividing 1024 GB by 4 GB. Shown in data structure 800, each cache line indicated by one of the indices contains a tag, a corresponding physical address represented by flash memory chip number (FM#), block number (BLK#), page number (PAGE#), cluster valid flags, a “flush-to-HDD” flag, a “reside-in-RAM” flag and usage or access frequency 838. In one embodiment, usage or access frequency 838 is configured to store the sequence number of the data file accessed by the data access frequency application module 115 of FIG. 1. In other words, the data block used for storing a particular data file is assigned a usage or access frequency with the sequence number of that particular data file.

In this example, each index corresponds to 16 clusters and each cluster represents 4 KB of data. In other words, the total number of possibilities of cache entry is equal to 1024 GB/(256*16*4 KB). The “flush-to-HDD” and “reside-in-DRAM” flags are indicators for managing data between RAM buffer 254, flash memory cache 256 and the HDD 258.

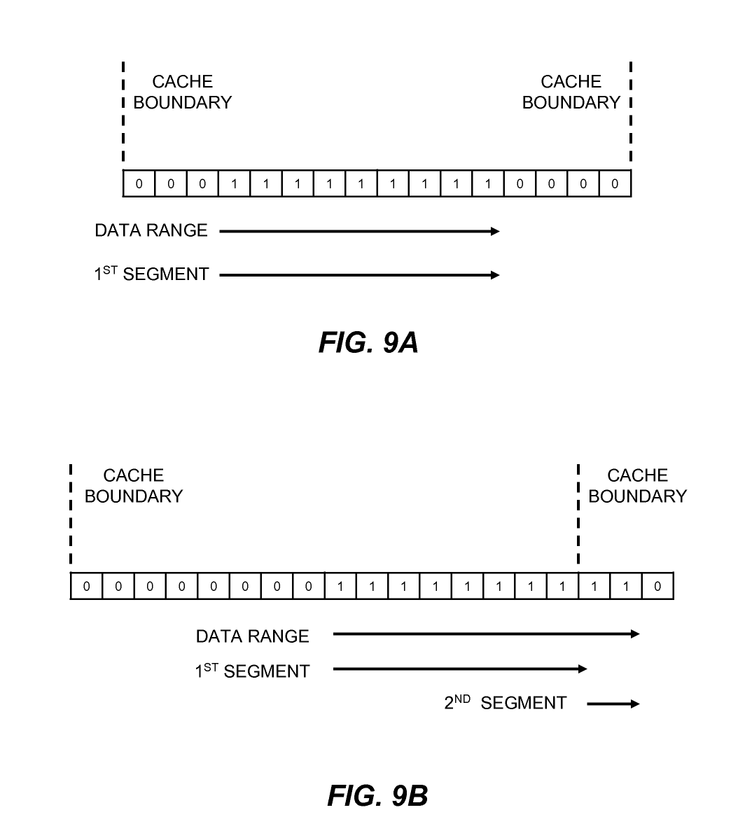

FIGS. 9A-9B are diagrams showing data transfer commands affected by data cache boundaries. In the example shown in FIG. 9A, data range (shown with “1”s in the boxes) is within the data cache boundary. Only one date segment is required to complete the data transfer command. In the example shown in FIG. 9B, the data range (shown with “1”s) straddles a data cache boundary. As a result, the data transfer command needs to be divided into two segments to complete. In other instances, more than two segments may be required if two data cache boundaries are straddled by a data range.

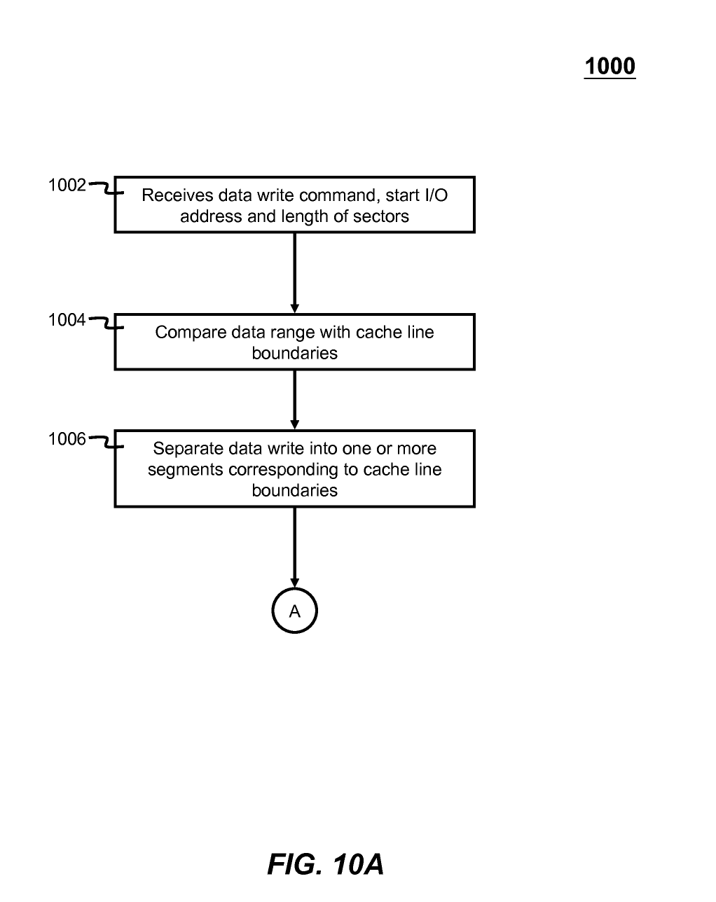

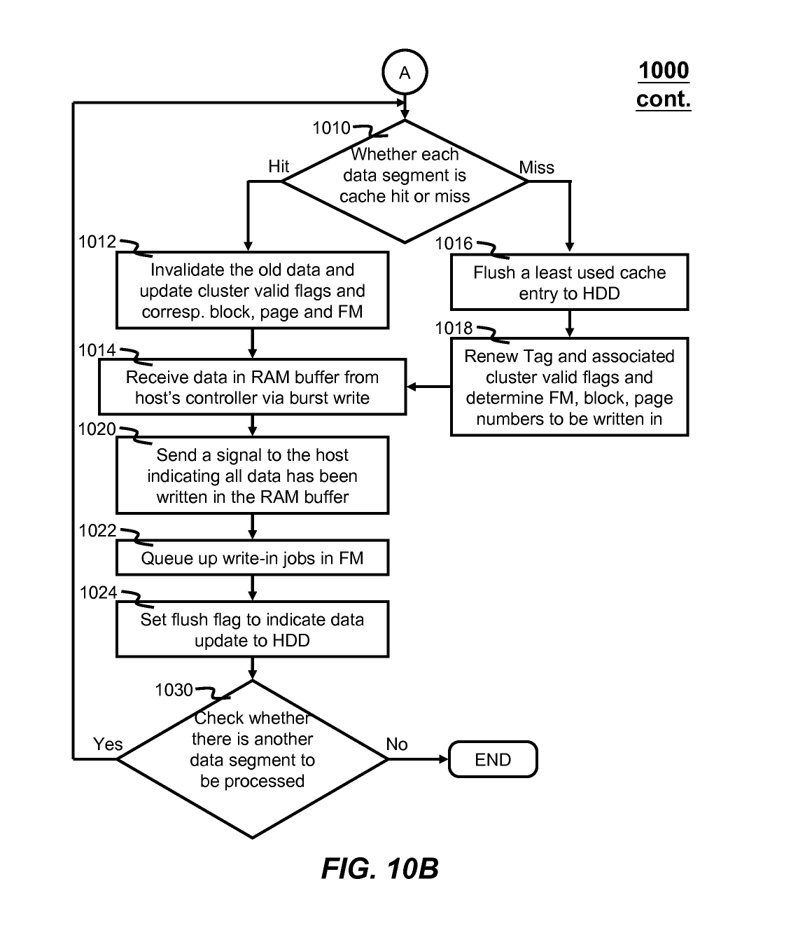

FIGS. 10A-10B are collectively a flowchart showing a data write transfer command being processed in a hybrid storage device 250. At step 1002, a data write command is received in the hybrid storage device 250. Within each command, a start address and date range (in terms of data sectors) can be extracted. Data range is then examined and compared with data cache boundaries at step 1004. One or more corresponding data segments are formed at step 1006. Next, at decision 1010, it is determined whether each data segment exists in data cache or not. If “yes” (i.e., cache hit), the old data in data cache is invalidated and cluster valid flags are updated for corresponding block, page and flash memory number (FM#) at step 1012. Next at step 1014, data is received in RAM buffer 254 from the host's controller 251 (e.g., via burst write). Otherwise, if “no” (i.e., cache miss), a least used data cache entry from data cache 256 to HDD 258 at step 1016. Then at step 1018, tag and associated cluster valid flags are renewed. Corresponding FM#, block and page numbers are determined to be written in before receiving the data at step 1014.

Next, at step 1020, a signal is sent to the host 251 indicating the completion of the data transfer after all data have been received in the RAM buffer 254. One or more data write-in jobs are set and queued up at step 1022. At step 1024, a data flush flag is set to indicate data update to HDD 258. Finally, at decision 1030, it is determined whether there is another data segment to be processed. If “yes”, the process 1000 moves back to decision 1010 for the next data segment. Otherwise, the process ends.

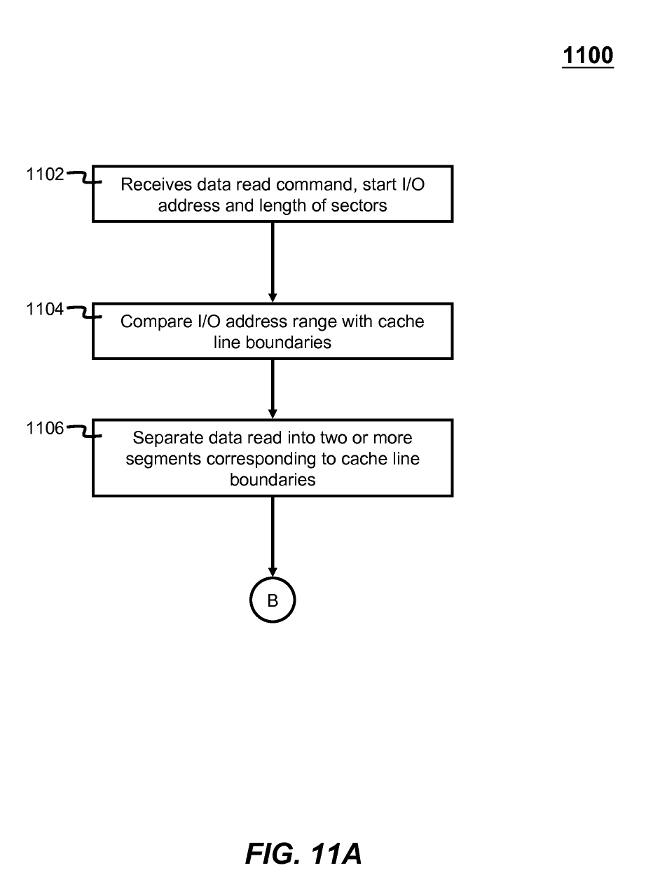

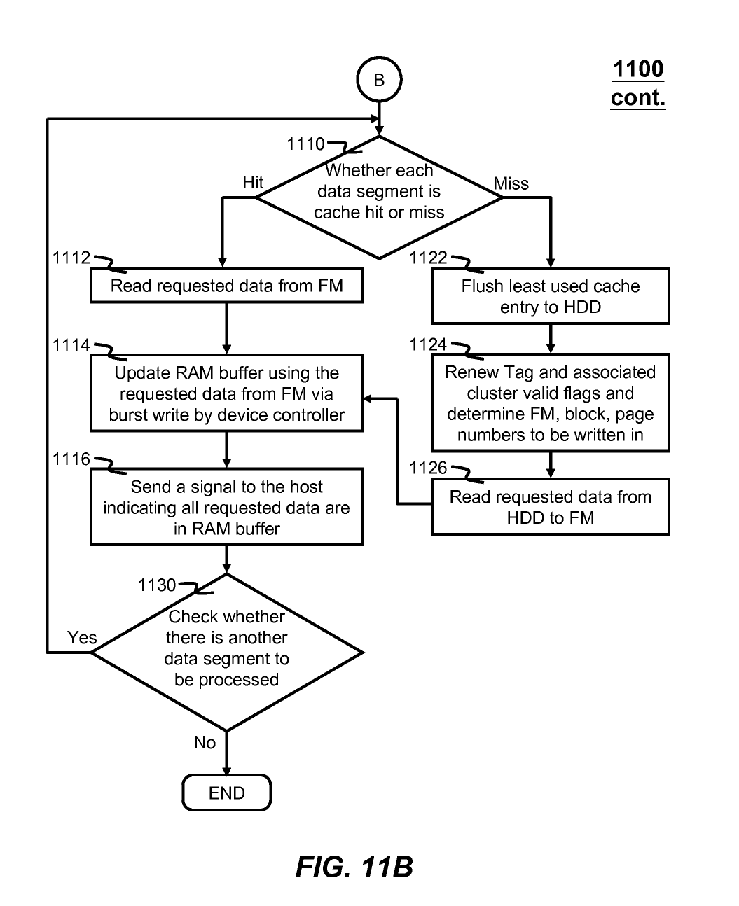

For a data read command, a flowchart is shown in FIGS. 11A-11B. Process 1100 is similar to process 1000 for receiving the data transfer command and dividing the data range into one or more data segments shown in steps 1102-1106. After that, at decision 1110, it is determined whether each segment is a cache hit or miss. If “miss”, process 1100 flushes a least used data cache entry to HDD 258 at step 1122. Next, at step 1124, tag and associated cluster valid flags are renewed. Corresponding FM#, block and page numbers are determined to be written in. The requested data are read from HDD 258 into data cache 256 at step 1126. Then the RAM buffer 254 is updated with the requested data in the cache at step 1114 (e.g., via a burst write by the hybrid storage device). If “hit”, process 1100 reads the requested data from the data cache at step 1112 before updating the RAM buffer 254 at step 1114. Next, at step 1116, a signal is sent to the host 251 to indicate that all requested data have been ready in the RAM buffer. Finally, process 1100 moves to decision 1130 to determine whether there is another data segment to process. If “yes”, process 1100 moves back to decision 1110 for anther data segment. Otherwise, process 1100 ends.

FIG. 12A is a flowchart illustrating an exemplary process 1200 of using a data access frequency threshold to determine data placement into SSD and HDD in a hybrid storage device 220 of FIG. 2A. Process 1200 starts by storing critical system data into a first and generally faster data storage (e.g., flash memory, SSD 227). Exemplary critical system data are shown in FIG. 3 and corresponding descriptions thereof. Next, at step 1204, other regular data (e.g., in forms of data units) are initially stored in the first data storage until the capacity (e.g., address SSDA 514 shown in FIG. 5) has been reached. Optionally, data units associated with a data file specified by a user can be stored in the SSD. For example, a user knows that a particular data file or application will be used extensively, then data units corresponding to these file or application are specifically designated to be stored in SSD. As a result, access time of the data file and start-up time of the application would be faster in such data placement.

Remaining regular data are stored in a second and generally slower data storage (e.g., HDD 228 in FIG. 2A). At step 1206, all regular data are tracked for data access frequency (e.g., using a data access frequency application module 115 of FIG. 1 in conjuction with the data mapping table 800 of FIG. 8).

Next, a data access frequency threshold is established for determine frequently accessed and least-recent-used data at step 1208. There are a number of different means to establish the threshold. The data access frequency threshold can be predefined statically either by user or a default value. It can also be dynamically defined by calculating a number based on data accessing patterns (e.g., average access frequency of all data in the first data storage, highest access frequency of data in the second data storage, etc.). There can be a number of different means to calculate the average. Once the data access frequency threshold is established, a least used regular data unit in the first data storage is swapped with a data unit having an access frequency higher than the data access frequency threshold in the second storage unit at step 1210. It is noted that the swapping operation in step 1210 is performed continuously to ensure all frequently accessed data are stored in the first data storage that provides fast data access rate. As a result, the hybrid storage device overcomes the shortcomings, problems and drawbacks of the prior art approaches.

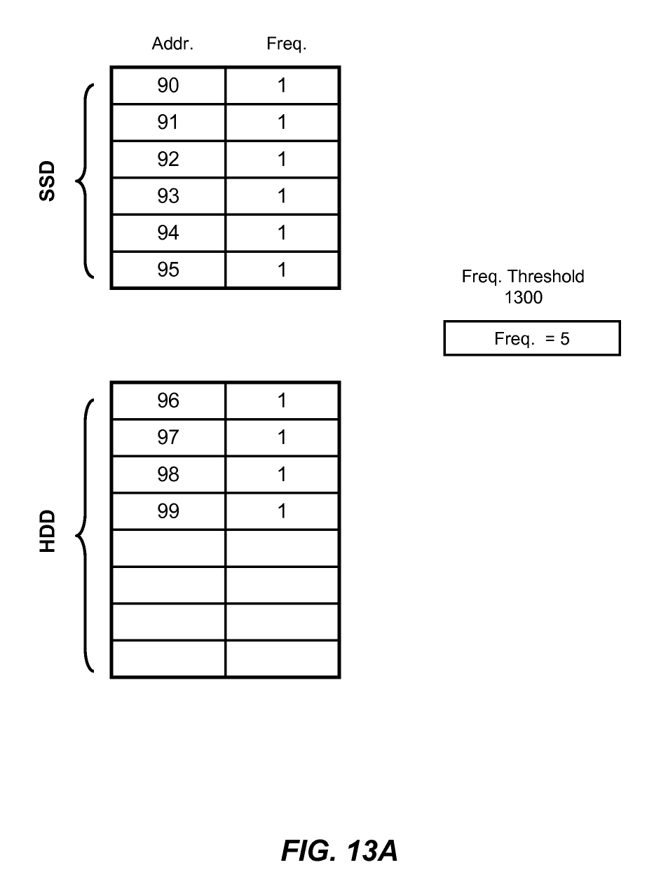

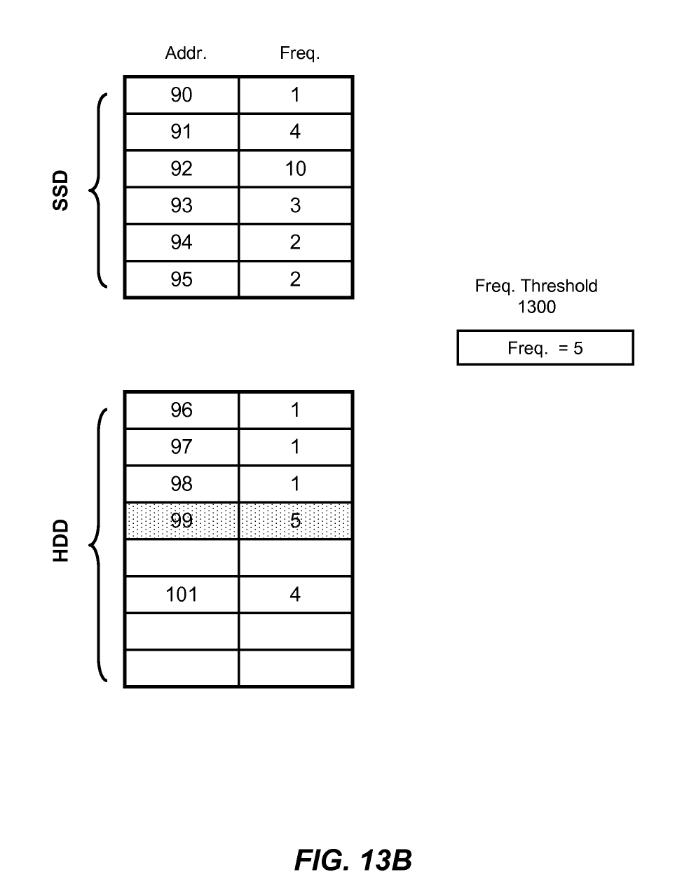

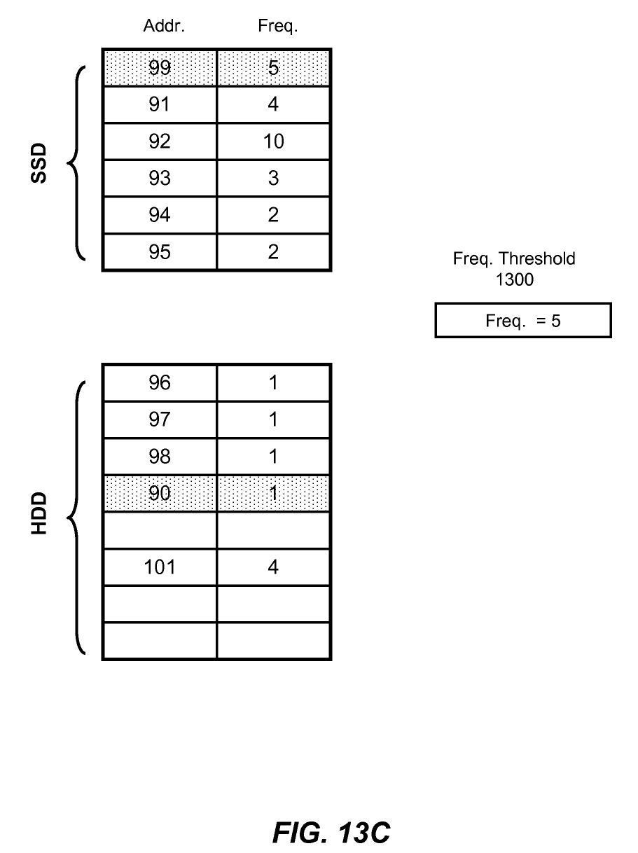

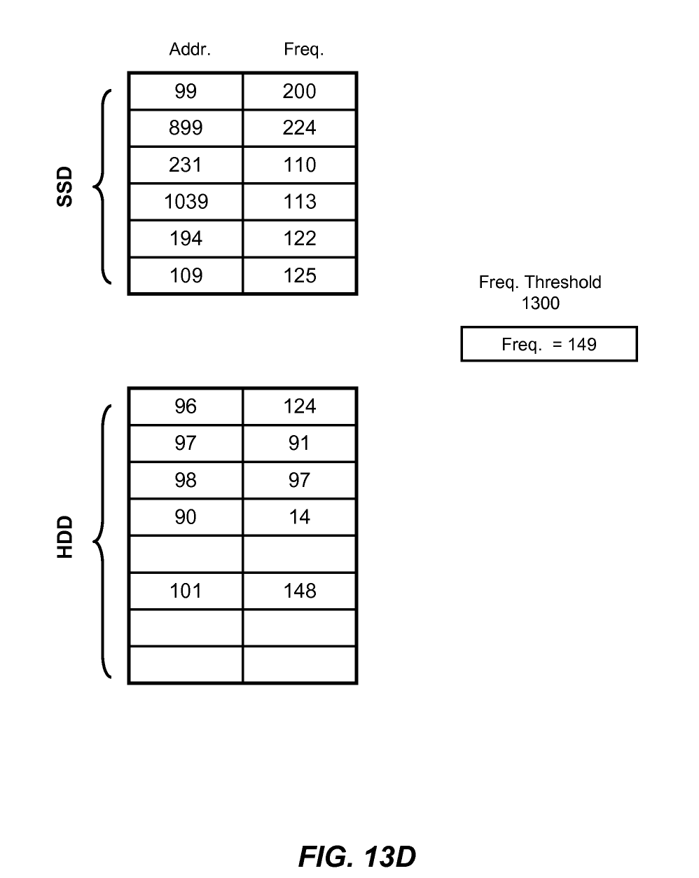

Although exemplary process 1200 and example shown in FIGS. 13A-13D have been described using a concatenation or big mode based hybrid storage device. It should be very obvious to those of ordinary skilled in the art that process 1200 can apply to a hybrid storage device having a data cache. Any data stored in the SSD would be copied to the HDD in the cache mode.

FIGS. 13A-13D show an example of data placement based on process 1200. In FIG. 13A, SSD is initially filled with the critical system data (not shown) and regular data units (shown as addresses 90-95 with each having access frequency of 1). Remaining regular data units are stored in HDD (shown as addresses 96 and above). A data access frequency threshold 1300 for determining least-recent-used data is set as five (5) initially. The data access frequency threshold 1300 can be determined by the controller of hybrid storage device or optionally by the host.

In FIG. 13B, after some data transfer operations, one of the data units (i.e., address 99 highlighted with shaded background) has reached the data access frequency threshold 1300 of five. A least used entry in SSD is determined (i.e., address 90). These two data units are swapped and shown in FIG. 13C.

FIG. 13D shows another snap-shot of the hybrid storage device, in which the threshold is dynamically calculated (i.e., “149”). In this example, it is a simple average of the access frequency of all data units in SSD. Determinations of the data access frequency threshold 1300 can be through different means, for example, medium value, highest value in the HDD, etc.

Referring now to FIG. 12B, it is shown an exemplary process 1250 of using a file size threshold to determine data placement in a hybrid storage device. Process 1250 starts by defining the file size threshold initially at step 1252. The file size threshold is generally based on the total capacity of the SSD (e.g., ten percent 10%). Next, at step 1254, the file size threshold is adjusted based on the remaining free capacity of the SSD if needed. Process 1250 then moves to decision 1256, in which it is determined whether a file's size is larger than the file size threshold. If “yes”, the file is stored in HDD at step 1260. Otherwise the file is stored in SSD at step 1258. Process 1250 can only be implemented in a processor of the host. Because the hybrid storage device's controller does not have any knowledge of the structure of files.

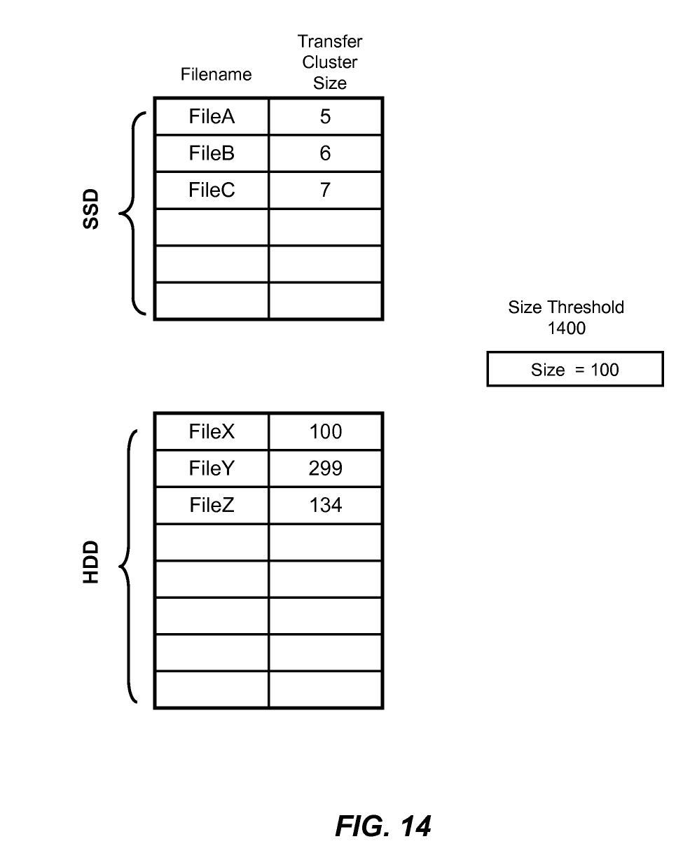

FIG. 14 shows an example using process 1250. A file size threshold 1400 is defined as 100 transfer clusters in this example. “FileA”, “FileB” and “FileC” are placed in SSD because their size is below the file size threshold 1400. Whereas “FileX”, “FileY” and “FileZ” are stored in HDD because their size is larger than the file size threshold 1400. It is noted that the file size threshold 1400 can only be determined in the host's processor because only the host can see the file structure.

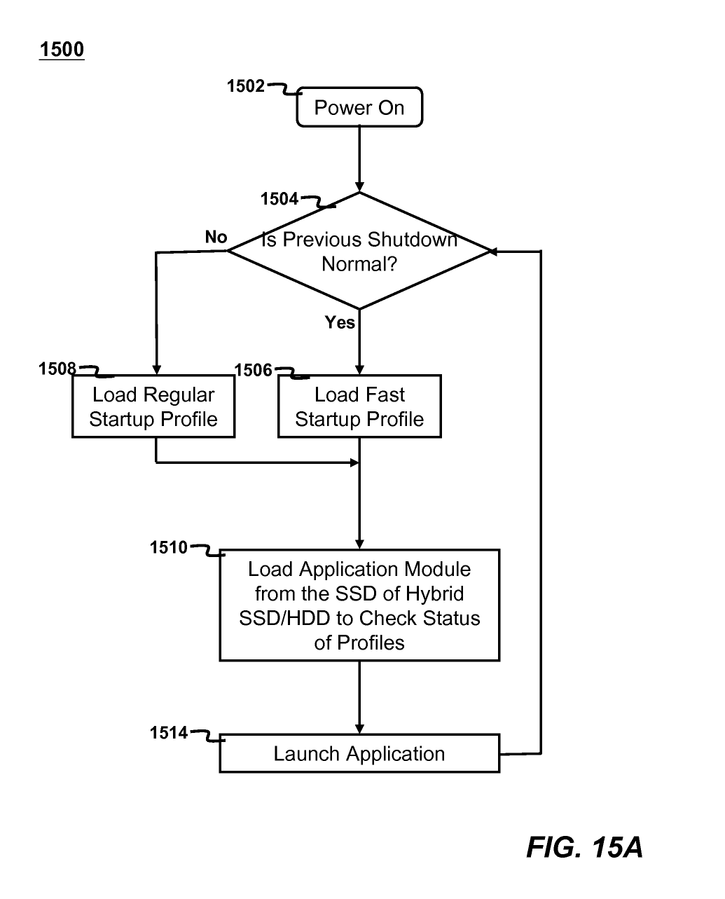

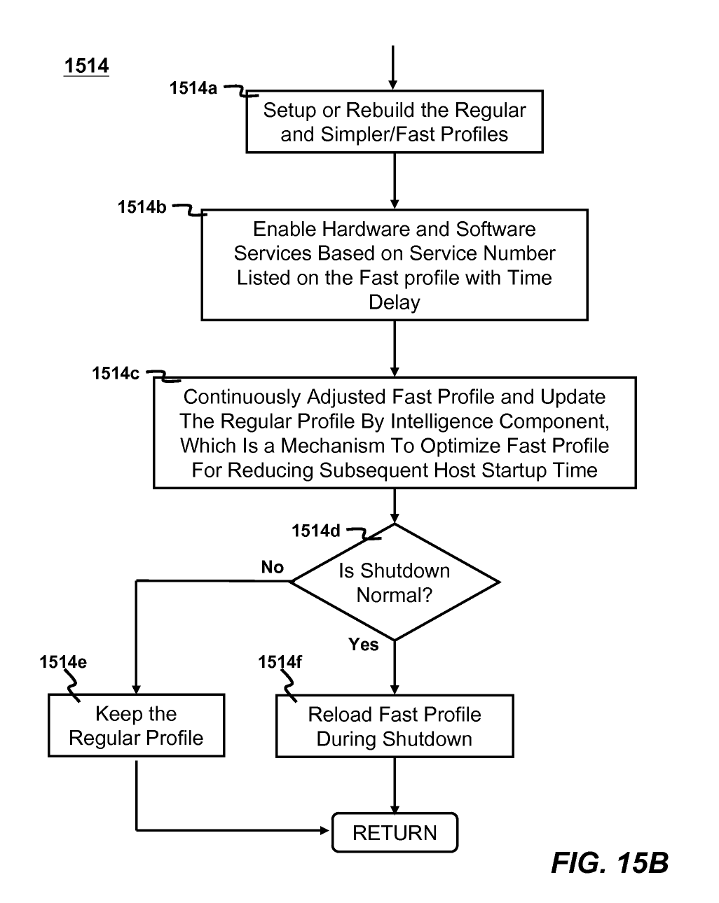

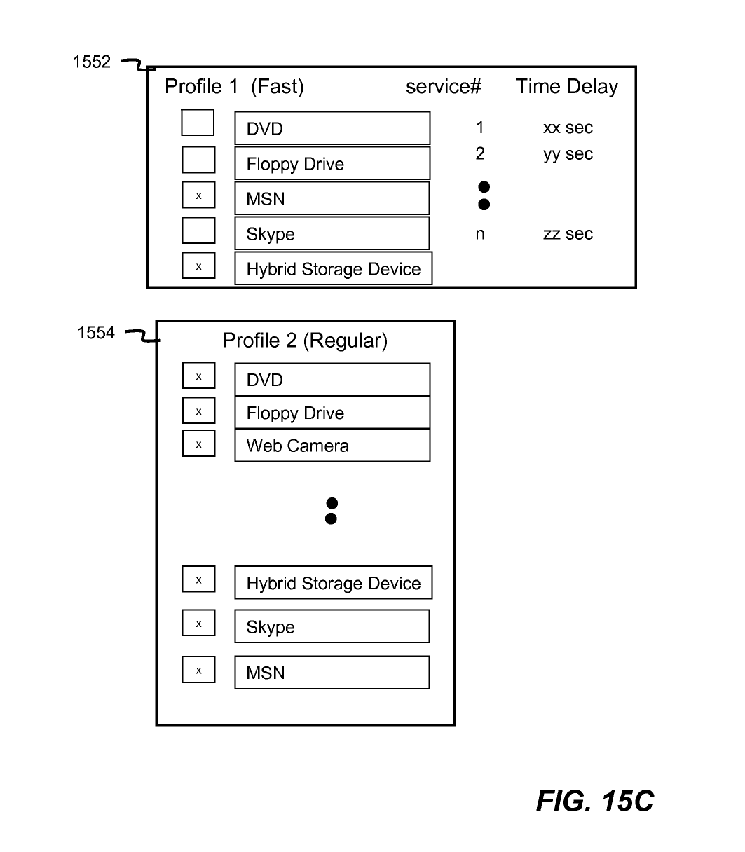

Referring now to FIGS. 15A-15B, there is shown a flowchart illustrating an exemplary process 1500 of reducing startup time of a host, to which a hybrid storage device (e.g., hybrid storage device 120 of FIG. 1A) is operatively adapted. Process 1500 is preferably understood with previous figures especially FIG. 1A. Process 1500 starts when a host 110 is powered on at step 1502. Next, at decision 1504, it is determined whether the previous shutdown of the host 110 is performed normally or not. If “no”, a regular profile that contains all possible hardware and software services (e.g., ‘Profile 2’ 1554 in FIG. 15C) is loaded at step 1508. Otherwise, a simpler profile or fast profile (e.g., ‘Profile 1’ 1552) is loaded at step 1506. As shown on FIG. 15C, ‘Profile 1’ 1552 contains only a hybrid storage device and MSN, while ‘Profile 2’ 1554 contains numerous hardware and software services, for example, DVD, floppy drive, web camera, blue tooth, router, serial/parallel port devices, smartcard, card reader, network card, mouse, keyboard, MSN, Skype, and human interface device. Because the simpler profile contains very few number of hardware and software services (e.g., only two shown in “Profile 1” 1552), the host 110 is booted up substantially faster. Startup time reduction is therefore achieved. Further shown in ‘Profile 1’ 1552 for each software and hardware services is a corresponding time delay, for example, DVD (service number 1) is scheduled to delay xx seconds, while hybrid storage device is scheduled for no delay.

Next, at step 1510, an application module 115 is loaded from SSD 127 of the hybrid storage device 120 to check status of the profiles. The application module 115 is then launched in a processor/CPU of the host 110 at step 1514. Generally, a graphical user interface (GUI) is displayed for easier user interaction at this point. On exemplary application module 115 is in form of system program (e.g., “.sys” type of application), which is forcibly or mandatorily executed or loaded whenever a host 110 is powered on. Only immediately required hardware (e.g., hybrid storage device) and software components are enabled using such application module.

Details of step 1514 are shown in FIG. 15B. First, at step 1514a, the regular profile and the fast/simpler profile are either setup initially or rebuilt in subsequent operations. Next, at step 1514b, hardware and software services are enabled in accordance with the time delays according to the time delays defined in the fast/simpler profile. In other words, selective ones of the hardware and software services are enabled later on when the host 110 is not as busy. Service items may include, but are not limited to, device drivers, software packages, etc.

At step 1514c, an intelligence component (e.g., artificial intelligence (AI) engine) of the application module 115 continuously adjusts the fast/simpler profile and records/updates new required services to the regular profile to reflect the requirements/access habits of the host over a period of time. In other words, the regular profile will all accessed hardware and software services of the host 110. The simpler/fast profile is adjusted by the intelligence component to optimize its contents to reduce the host's subsequent startup time (boot-up time). Finally, at decision 1514d, it is determined whether a shutdown operation is normal. If ‘Yes’, at step 1514f, the simpler/fast profile is loaded by the application module 115 before the host 110 is shut down to ensure a fast boot-up or startup at next powered on of the host 110. Otherwise, the host 110 keeps the regular profile at step 1514e to ensure the host 110 can be restored to the state before abnormal shutdown.

The algorithms and displays presented herein are not inherently related to any particular computer or other apparatus. Various general-purpose systems may be used with programs in accordance with the teachings herein, or it may prove convenient to construct more specialized apparatus to perform the required method operations. The required structure for a variety of these systems will appear from the description below. In addition, embodiments of the present invention are not described with reference to any particular programming language. It will be appreciated that a variety of programming languages may be used to implement the teachings of embodiments of the invention as described herein.

The background of the invention section may contain background information about the problem or environment of the invention rather than describe prior art by others. Thus inclusion of material in the background section is not an admission of prior art by the Applicant.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas SSD has been shown and described as flash memory. It can be another storage medium that provides faster data access to the hard disk drive to achieve the same objective. Further, concatenation mode and safe mode have been described and shown as two alternatives for the hybrid storage device, other equivalent alternatives may achieve the same purpose, for example, a specific method that uses a combination of both modes. Moreover, the regular and simpler/fast profiles for reducing host startup time have been described and shown being stored in SSD, they may be stored in HDD to accomplish the similar. Whereas the method for reducing startup time of the host has been described and shown for the hybrid storage device of SSD and HDD, the method can be used for a storage device containing HDD only. Finally, although intelligence component of the application module has been described and shown to adjust and update a profile, user can control and perform the similar functions to achieve the same. In summary, the scope of the invention should not be restricted to the specific exemplary embodiments disclosed herein, and all modifications that are readily suggested to those of ordinary skill in the art should be included within the spirit and purview of this application and scope of the appended claims.

We claim:

1. A hybrid storage device comprising:
a hybrid storage device controller;
a solid-state disk (SSD) coupled to the hybrid storage controller, said SSD being configured to store critical system data for supporting start-up operation and to store a first group of data units that are determined as frequently accessed and said SSD further comprising more than one identical flash memory devices controlled by a Redundant Array of Independent Disk controller;
at least one hard disk drive (HDD) coupled to the controller, said at least one HDD being configured to store a second group of data units that are determined as least-recent-used;
a random access memory (RAM) buffer operatively coupled to the hybrid storage controller, being configured to maintain a mapping table of the first and second group of data and a data access frequency threshold that is used for determining frequently used and least-recent-accessed data;
an input/output interface coupled to the hybrid storage controller to transmit data to the hybrid storage device from the host; and
wherein an application module executed on the host is configured for determining data access frequency and the first and second groups of data units.

2. The hybrid storage device of claim 1, wherein said hybrid storage controller is configured to concatenate said SSD and said at least one HDD into a single logical partition.

3. The hybrid storage device of claim 2, wherein the first group of data units and the second group of data units are independent with each other.

4. The hybrid storage device of claim 2, wherein said at least one HDD is configured for storing a copy of said SSD's contents in a reserved data section or area.

5. The hybrid storage device of claim 1, wherein said critical system data comprises Master Boot Record, Basic Input/Output System (BIOS) Parameter Block, Master File Table records.

6. The hybrid storage device of claim 1, wherein the threshold is calculated using data access patterns dynamically.

7. The hybrid storage device of claim 6, wherein the data access patterns are represented as a formula based on an average access frequency of the first group of data units.

8. The hybrid storage device of claim 6, wherein the threshold is set initially to a predefined value by user.

9. The hybrid storage device of claim 1, wherein said input/output interface comprises one of Serial Advanced Technology Attachment (SATA), Parallel ATA (PATA), Universal Serial Bus (USB), Peripheral Component Interconnect Express (PCIe), embedded Security Digital (eSD), and embedded MultiMediaCard (eMMC).

10. The hybrid storage device of claim 1, further comprises an embedded flash memory controller that controls one or more embedded flash memory devices.

11. The hybrid storage device of claim 1, wherein said data mapping table includes data access frequency of said each of the first group and the second group of data units, said data access frequency is set by the application module further configured for extracting sequence number of a data file.

12. A method of determining data placement in a hybrid storage device made of solid-state disk (SSD) and at least one hard disk drive (HDD), said method comprising:
storing critical system data and a first group of data units into the SSD initially until the SSD is full, wherein said SSD further comprises more than one identical flash memory devices controlled by a Redundant Array of Independent Disk controller;
storing a second group of data units into said at least one HDD, said second group of data units comprises initially those data cannot fit into the SSD;
keeping an access frequency of each of the first group and the second group of data units in a data mapping table;
establishing a data access frequency threshold for determining frequently used and least-recent-used data; and
continuously swapping a data unit in the second group having the access frequency higher than the threshold with a least-accessed data entry in the first group, such that no data unit in the second group has the access frequency larger than the data access frequency threshold.

13. The method of claim 12, further comprises forming said SSD and said at least one HDD into a single logical partition.

14. The method of claim 12, further comprises forming said SSD as a data cache for said at least one HDD.

15. The method of claim 12, said establishing the data access frequency threshold further comprises statically assigning a number as the data access frequency threshold.

16. The method of claim 13, said establishing the data access frequency threshold further comprises dynamically calculating a number based on data access patterns of all data units in the said first group as the data access frequency threshold.

17. The method of claim 12, further comprises specifying a particular data file or application to be stored in the SSD by a user via an artificial intelligence means.

18. A method of reducing startup time of a host having a hybrid storage device operatively adapted thereto, the hybrid storage device contains a solid state drive and at least one hard disk drive, said method comprising:
defining first and second profiles, the first profile containing one or ones of hardware and software services that are mostly desired with respects to a hybrid storage device, while the second profile containing all of the hardware and software services;
loading the first profile when previous host shutdown is determined to be normal;
otherwise loading the second profile;
loading an application module from the hybrid storage device;
enabling the hardware and software services in the first profile according to time delays specified therein;
continuously adjusting and optimizing the first profile and updating the second profile over time based on the host's heuristic usage by an intelligent component of the application module, wherein the first profile is optimized to reduce the host's subsequent startup time; and
loading the first profile before shutting down.

19. The method of claim 18, wherein the first and second profiles and said intelligence component of the application module are configured to be stored in the solid state drive of the hybrid storage device.

20. The method of claim 18, wherein the second profile is configured for including all of the hardware and software services of the host.
